(19) United States
(12) Patent Application Publication
(10) Pub. No.: US 2003/0004939 A1
(43) Pub. Date: Jan. 2, 2003

(54) Search scheduling apparatus, program and recording medium having the same program recorded therein

(76) Inventors: Daisuke Yamaguchi, Kanagawa (JP); Noriyuki Yamamoto, Kanagawa (JP); Takuro Tamura, Kanagawa (JP)

Correspondence Address: CHRIS T. MIZUMOTO, Fish & Richardson P.C., Suite 2800, 45 Rockefeller Plaza, New York, NY, 10111, US

(21) Appl. No.: 10/154,007

(22) Filed: May 23, 2002

(30) Foreign Application Priority Data
Jun. 20, 2001 (JP) 2001-186907

(51) Int. Cl. G06F 7/00

(52) U.S. Cl. 707/3

(57) ABSTRACT

To provide a search scheduling apparatus which makes it possible to control influence given by a group of spots of nonspecific reaction or errors of the reaction to arrangement and search to arrange and search probe or the like having an objective characteristic among data of experimental results of an experiment using a microarray. If an expression intensity Ep(I) of a probe P(I), which hybridizes with a sample sm(X) as a search condition, that is, an expression intensity Ep(I)t of an objective probe P(I)t, is set and inputted for a desired sample sm(X) that a user wishes to search by an input/output apparatus 10, an arithmetic unit 20 finds out a microarray A(K) satisfying the search conditions based on a record of experimental results accumulated in a data set file apparatus and displays search results on the input/output apparatus 10.

### BACKGROUND OF THE INVENTION

1. Field of the Invention

The present invention relates to a search scheduling apparatus for classifying and searching microarrays, probes or the like with an objective characteristic with respect to a microarray, in which multiple biopolymers or the like for specifically hybridizing with specific DNAs and proteins are spotted, from measurement results data such as hybridizing reaction, a program for the search scheduling apparatus and a recording medium having the program recorded therein.

2. Description of the Related Art

Conventionally, in an experiment using microarrays formed by arranging and immobilizing many kinds of probes, a target to be a research object is caused to apply (react) to these microarrays, whereby combination or non-combination of the microarrays and the target is observed.

Such a microarray is configured such that one kind of probe is immobilized for one spot on the microarray using an apparatus such as a spotter and various kinds of probes are arranged and immobilized in all spots.

Observation of a state of combination of the various kinds of probes arranged and immobilized on the microarray and a target to be caused to react (apply) to this microarray (whether or not combination exists) is performed by measuring an amount of hybridization for each spot of the microarray.

The measurement of an amount of hybridization is performed by measuring an expression intensity (e.g., fluorescent amount) by a fluorophor substance or the like combined to the target in advance for an experimental results of the measurement, that is, experimental results are obtained as numerical values.

Results of measurement of each spot, that is, an expression intensity of each probe in the above-described experiment using microarrays are collected and accumulated. Various analyses are performed based on the results.

In recent years, a DNA microarray in which DNAs are immobilized as probes has been rapidly propagating as such a microarray.

However, a data amount of experimental results obtained by an experiment using such a microarray is extremely enormous and it is a subject to find how to classify and analyze the experimental results.

For example, in an experiment using a microarray, one target is applied to one microarray in which various kinds of probes are arranged and immobilized and expression intensities for the same target are compared among different kinds of probes.

In addition, a plurality of microarrays in which a plurality of probes are arranged in the same manner are prepared and different targets are applied to each of the plurality of microarrays to compare expression intensities with respect to different targets with the same probe among the microarrays.

However, when a large amount of data by such an experiment are collected and accumulated, work is required for searching a target having an objective characteristic out of a large amount of accumulated data of experimental results, classifying probes according to certain kinds of characteristics, or the like for the above described classification and the analysis.

Although arrangement and search of probes have been performed in the past in the order of expression intensities, in the order of names and for each group of probes, errors and nonspecific reactions for each probe kind are often included in experiment data, which make classification and analysis of experimental results difficult.

### SUMMARY OF THE INVENTION

The present invention has been achieved in view of the above-described drawbacks and it is an object of the present invention to provide a search scheduling apparatus for controlling influence given to arrangement and search by a group of spots of nonspecific reactions and errors of the reactions to allow arrangement and search of data having an objective characteristic (inherent data such as a microarray, a probe and a target) among data of experimental results of an experiment using such a microarray, a program for the search scheduling apparatus and a recording medium having the program recorded therein.

In order to solve the above-described problems, a search scheduling apparatus of the present invention is characterized by comprising:

a data set file having a record for search in which a value of expression intensity of each spot on a microarray provided with a spot to which a probe is immobilized is stored in the case where a target is applied to the microarray, and a record for histogram in which, based on a value of expression intensity for each probe type or microarray which is stored in the record for search, the number of microarrays or probes according to a value of expression intensity for each probe type or microarray is stored; and

search means for searching, when a predetermined value of expression intensity for one probe or microarray is input as a search condition, the record for search for a probe or microarray of the search condition, so that a desired microarray or probe can be identified based on uniqueness on a histogram of expression intensity for each probe or microarray which is searched from the record for histogram.

Consequently, it becomes possible to control influence given by a group of spots of nonspecific reaction or errors of the reaction to arrangement and search to arrange and search data (inherent data such as a microarray, a probe and a target) having an objective characteristic among data of experimental results of an experiment using a microarray.

In addition, the search scheduling apparatus of the present invention is characterized in that the uniqueness on the searched histogram of expression intensity for each probe or microarray is judged based on a score representing a degree of uniqueness.

Consequently, it becomes possible to quantitatively judge data (inherent data such as a microarray, a probe and a target) having an objective characteristic.

In addition, the present invention is characterized in that the present invention is a program for causing a computer to function as a search scheduling apparatus or a computer readable recording medium having the program recorded therein, the search scheduling apparatus comprising:

a data set file having a record for search in which a value of expression intensity of each spot on a microarray provided with a spot to which a probe is immobilized is stored in the case where a target is applied to the microarray, and a record for histogram in which, based on a value of expression intensity for each probe type or microarray which is stored in the record for search, the number of microarrays or probes according to a value of expression intensity for each probe type or microarray is stored; and

search means for searching, when a predetermined value of expression intensity for one probe or microarray is input as a search condition, the record for search for a probe or microarray of the search condition, so that a desired microarray or probe can be identified based on uniqueness on a histogram of expression intensity for each probe or microarray which is searched from the record for histogram.

Consequently, it becomes possible to utilize a computer as a search scheduling apparatus that is capable of controlling influence given by a group of spots of nonspecific reaction or errors of the reaction to arrangement and search to arrange and search data (inherent data such as a microarray, a probe and a target) having an objective characteristic among data of experimental results of an experiment using a microarray.

In addition, a search scheduling apparatus of the present invention is characterized by comprising:

a data set file having a record for search in which a value of expression intensity for each spot on a microarray with at least one spot to which one probe is immobilized is stored in the case where a target is applied to the microarray, and a record for histogram in which, based on a value of expression intensity for each spot on the microarray which is stored in the record for search, the number of microarrays having a spot provided with a probe of a predetermined kind is stored while being classified according to predetermined intervals of the value of expression intensity, for each kind of probe immobilized to the spot of the microarray; and

a search means for searching, when a predetermined value of expression intensity for a probe of a predetermined kind is input as a search condition for searching for a desired microarray, the record for search for a microarray with a spot to which the probe of the predetermined kind is immobilized, and determining the uniqueness of the value of expression intensity of the probe of the predetermined kind in the searched microarray on the basis of the number of microarray that is stored in the histogram for the probe of the predetermined kind and which is of a value interval containing the value of expression intensity of the probe of the predetermined kind in the searched microarray, so that a desired microarray can be identified from the searched microarray on the basis of the uniqueness determined for each searched microarray.

In addition, a search scheduling apparatus of the present invention is characterized by comprising:

a data set file having a record for search in which a value of expression intensity for each spot on a microarray with at least one spot to which one probe is immobilized is stored in the case where a target is applied to the microarray, and a record for histogram in which, based on a value of expression intensity for each spot on the microarray which is stored in the record for search, the number of probes immobilized to the spot on the microarray to which a target of a predetermined kind is applied is stored while being classified according to predetermined intervals of value of expression intensity, for each kind of target applied to the microarray; and

a search means for searching, when a value of expression intensity for a target of a predetermined kind is input as a search condition for searching for a desired microarray, the record for search for a microarray to which the target of the predetermined kind is applied, and determines the uniqueness of the value of expression intensity of the probe immobilized to each spot on the searched microarray on the basis of the number of the probes for each value section which are stored in the record for histogram for the target of the predetermined kind, so that a microarray with a spot to which a desired probe is immobilized can be identified from the searched microarray on the basis of the uniqueness determined for each searched probe.

### BRIEF DESCRIPTION OF THE DRAWINGS

FIG. 1 is a block diagram showing a configuration of a search scheduling apparatus 1 of an embodiment of the present invention;

FIG. 2 is a diagram of various data records provided in a data set file apparatus 30;

FIG. 3 conveniently illustrates an example of experimental results of an experiment that is performed by using N microarrays A(1) to A(N) (N is a natural number) to which probes p(1) to p(M) are immobilized;

FIG. 4 is a flow chart of processing for preparing a data set for search that is performed by an arithmetic unit 20 when experimental results are supplied;

FIG. 5 is a flow chart showing an example of processing for preparing and updating an interval record for a histogram 33;

FIG. 6 is a table briefly showing a specific example of an interval setting record 34;

FIG. 7 illustrates an example of a histogram HGpb of a probe Pb that is prepared based on an interval record for a histogram Hpb of the probe Pb as a result of the processing for preparing and updating a histogram represented by steps S14-2 to S14-6;

FIG. 8 illustrates an example of a histogram HGpe of a probe Pe that is prepared based on an interval record for a histogram Hpe of the probe Pe;

FIG. 9 is a flow chart showing processing for executing search performed by the arithmetic unit 20 of the search scheduling apparatus 1;

FIG. 10 illustrates an example of display by a display apparatus 12 of an input/output apparatus 10 when a search condition is set and inputted;

FIG. 11 illustrates an example of display by the display apparatus 12 concerning experimental results;

FIG. 12 illustrates an example of a histogram HGa(2) of the micro-array A(2) that is prepared based on an interval record for a histogram Ha(2) of the microarray A(2);

FIG. 13 illustrates an example of a histogram HGa(9) of the microarray A(9) that is prepared based on, for example, an interval record Ha(9) of the microarray A(9); and

FIG. 14 illustrates an example of display by the display apparatus 12 of the input/output apparatus 10 concerning results of search of a probe p(X).

### DETAILED DESCRIPTION OF THE PREFERRED EMBODIMENTS

An embodiment of the present invention will be described with reference to the attached drawings.

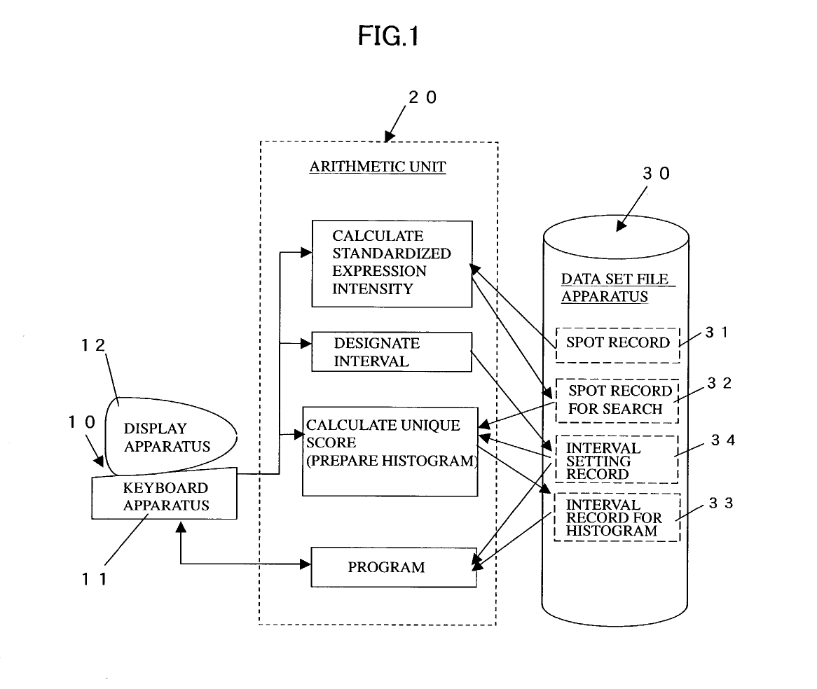

FIG. 1 is a block diagram showing a configuration of a search scheduling apparatus 1 of an embodiment of the present invention.

The search scheduling apparatus 1 is substantially constituted by an input/output apparatus 10 having a keyboard apparatus 1 and a display apparatus 12, an arithmetic unit 20 for performing various controls/arithmetic operations and a data set file apparatus 30 in which various kinds of data are recorded.

The input/output apparatus 10 inputs various kinds of data such as experimental results and search conditions from the keyboard apparatus 11 and displays various kinds of data such as results of search of recorded data on the display apparatus 12.

Further, experimental results can be automatically inputted in the arithmetic unit 20 by configuring a not-shown measuring apparatus of experimental results to be capable of exchanging data with the arithmetic unit 20 in advance and using this measuring apparatus as an input apparatus, rather than manually inputting the experimental data by the keyboard apparatus 11.

The arithmetic unit 20 is constituted by not-shown CPU, RAM, ROM, I/F (interface) or the like. The arithmetic unit 20 performs various kinds of individual processing relating to processing for setting data for search, processing for executing search or the like discussed below based on a program immobilized in the ROM in advance or a program immobilized in a recording medium such as a CD-ROM read by a recording medium recording device such as a CD-ROM drive attached to the arithmetic apparatus 20 or a program distributed from an external network via the I/F.

The data set file apparatus 30 is constituted by an external storage connected to the arithmetic unit 20 via the I/F, a data server connected to it via a network or the like.

In the case of this embodiment, the data set file apparatus 30 is provided with various data records such as a spot record 31, a spot record for search 32, an interval record for a histogram 33 and an interval setting record 34.

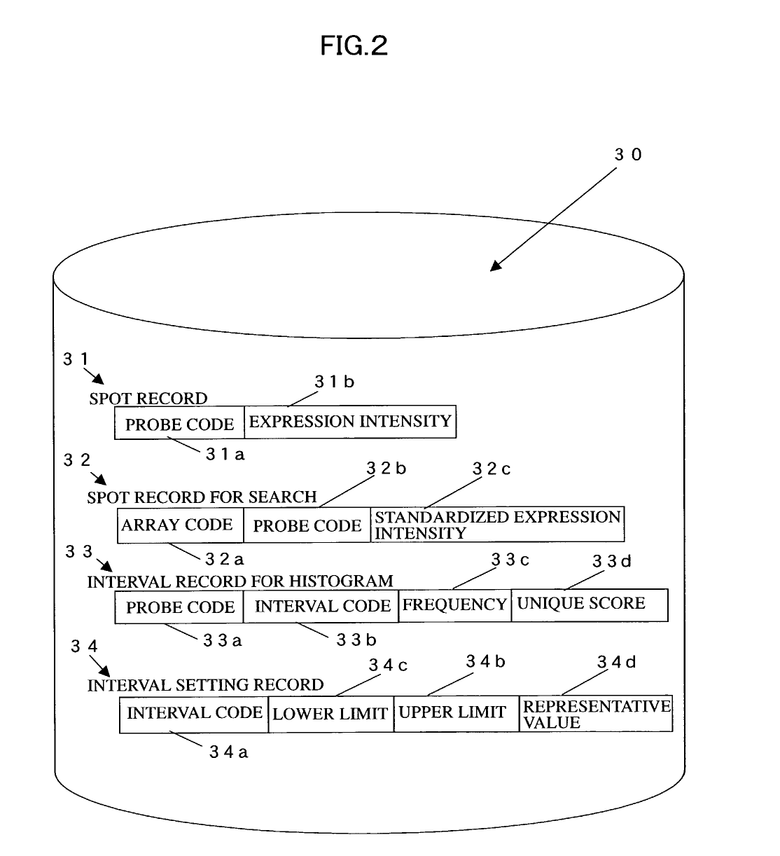

FIG. 2 is a diagram of the various data records provided in this data set file apparatus 30.

First, the spot record 21 is provided with a probe code area 31a and an expression intensity area 31b for storing experimental results for each spot inputted from the input/output apparatus 10.

The probe code area 31a stores probe codes representing identification (type) of a probe p(I) immobilized in a spot sp(I) (I is an arbitrary integer of 1≦I≦M) associating them to probe p(1) top(M) that are immobilized for respective spots sp(1) to sp(M) (M is a natural number) on a microarray A(K) (K is an arbitrary integer of 1≦K≦N, N is a natural number)

The expression intensity area 31b stores measurement data of an expression intensity such as an fluorescent amount obtained as experimental results associating the data with the respective spots sp(1) to sp(M), that is, the respective probes p(1) to p(M) stored in the probe code area 31a.

The spot record for search 32 is for accumulating data concerning experimental results using the microarrays A(1) to A(N) for the purpose of searching the results and is provided with an array code area 32a, a probe code area 32b and a standardized expression intensity area 32c.

The array code area 32a stores an array code representing identification for each of the microarrays A(1) to A(N) on which an experiment was performed.

The probe code area 32b stores probe codes of the probes p(1) to p(M) immobilized to the spots sp(1) to sp(M) on the microarray A(K) associating them with each microarray A(K) stored on the array code area 32a.

The standardized expression intensity area 32c stores a standardized expression intensity (standardized expression intensity) Ep(I) as experimental results associating it with each probe p(I) stored in the probe code area 32a.

Here, unlike the above-described expression intensity area 31b of the spot record 31, measurement data of an expression intensity such as a fluorescent amount or the like as experimental results is not directly stored in the standardized expression intensity area 32c. Instead, for example, if measurement data of a predetermined size is assumed to be a reference value, data obtained by standardizing (normalizing) measurement data of an expression intensity of experimental data with respect to this reference value is stored as standardized expression intensity Ep(I).

Thus, when a size of a value of the standardized expression intensity Ep(I) stored in the standardized expression intensity area 32c is referred to, not only a level of a hybridization amount with respect to a sample sm(K) applied as a target can be understood, but also a level of the hybridization amount can be contrasted and determined by relatively comparing a size of a value of the standardized expression intensity Ep(I) between different probes or different targets.

In addition, the interval record 33 for a histogram is prepared using data stored in the above-described spot record for search 32 and stores various kinds of data for a histogram for respective kinds of probes or respective microarrays.

For this purpose, the interval record for a histogram 33 is provided with a probe code area 33a storing probe codes and an interval code area 33b, a frequency area 33c and a unique score area 33d, which are associated with the probe code area 33a to be provided, respectively.

The interval setting record 34 is for defining an interval of a value to be utilized for data aggregation in order to prepare the above-described histogram and for other purposes. The interval setting record 34 has an interval code area 34a for storing interval code indicating identification of the interval, an upper limit area 34b and a lower limit area 34c for storing an upper limit value and a lower limit value for regulating the interval and an interval representative value area 34d for recording a representative value of the interval.

Actions of the search scheduling apparatus 1 of this embodiment consisting of the above-described configuration will be hereinafter described.

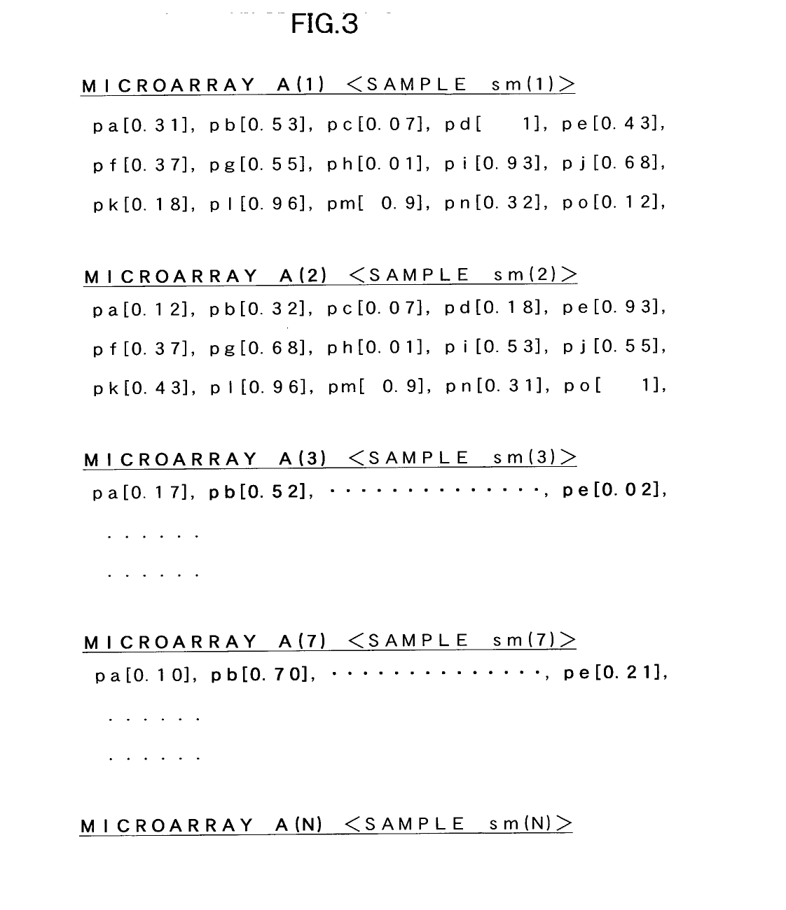

FIG. 3 conveniently illustrates an example of experimental results of an experiment performed using N microarrays A(1) to A(N) (N is a natural number) to which probes p(1) to p(M) are immobilized.

Further, in FIG. 3, for convenience of description, experimental results concerning probes Pa to Po consisting of probe codes pa to po among the probes p(1) to p(M) immobilized to each of spots sp(1) to sp(M) of each of the microarrays A(1) to A(N) are illustrated.

In FIG. 3, numeric values in parentheses beside the probe codes pa to po written for each of the microarrays A(1) to A(N) indicates standardized expression intensities Epa(K) to Epo(K) of each of the probes Pa to Po among standardized expression intensities Ep(1) (K) to Ep(M) (K) of the probes p(1) to P(M) calculated from results of measurement of expression intensities of an experiment in which a predetermined sample sm(K) is applied to the probes p(1) to p(M).

Here, an outline of the experiment using these microarrays A(1) to A(N) and processing for preparing a data set for search to be performed by the search scheduling apparatus 1 at the end of the experiment will be described.

The probes p(1) to p(M) such as specific DNAs and proteins of types different from each other are individually arranged and immobilized corresponding to spots sp(1) to sp(M) (not shown) on the microarrays.

The experiment is performed by applying one each of N types of samples sm(1) to sm(N) (not shown) as a target to the N microarrays A(1) to A(N) of the identical configuration to which the probes p(1) to p(M) are immobilized, respectively.

In this case, the N types of samples sm(1) to sm(N) contains specific DNAs, proteins or the like different from each other and, on the other hand, has a configuration in which a fluorophor substance or the like are combined to the specific DNAs and proteins in advance and a reaction amount of the combination is quantitatively measurable if the fluorophor substance is combined with the probes p(1) to p(M) by hybridization.

Consequently, after applying one sample sm(K) to one microarray A(K) as a target to cause it hybridize, an expression intensity such as a fluorescent amount for respective spots sp(1) to sp(M) of the microarray A(K) is measured, whereby a status of combination of the probes p(1) to p(M) immobilized to the spots sp(1) to sp(M) of the microarray A(K) ,respectively, and the applied sample sm(K) (whether combination exists or not, a hybridization amount or the like) can be observed.

Then, the experimental results are inputted from the keyboard apparatus 11 of the input/output apparatus 10 or an experiment measuring apparatus (not shown) that is directly connected to be capable of transmitting data and are supplied to the arithmetic unit 20.

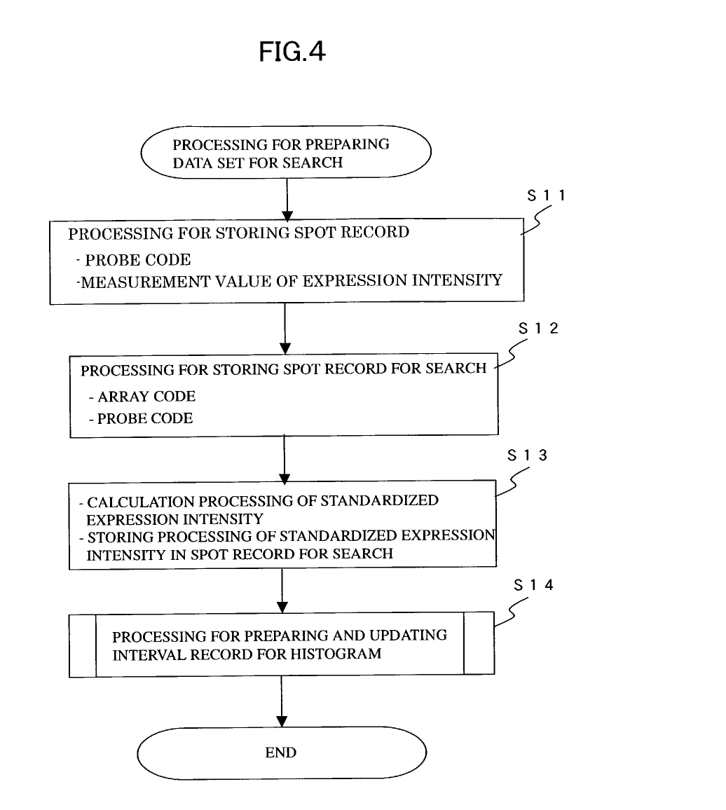

FIG. 4 is a flow chart of processing for preparing a data set for search that is performed by an arithmetic unit 20 when experimental results are supplied.

When an experiment for applying one sample sm(K) to one microarray A(K) as a target ends, data of experimental results such as an array code of the microarray A(K) corresponding to a type of the applied sample sm(K), probe codes (including probe codes pa to po) of probes p(1) to p(M) immobilized to spots sp(1) to sp(M) of this microarray A(K) and a measurement value of an expression intensity for each of the spots sp(1) to sp(M) of this microarray A(K) is supplied to the arithmetic unit 20.

In this processing for preparing data set for search, the arithmetic unit 20 first stores the supplied probe codes of the probes p(1) to p(M) and the measurement value data of the expression intensity measured for each of the spots sp(1) to sp(M) in the spot record 31 of the data set file apparatus 30 associating them with each other (step S11).

Consequently, the probe code area 31a and the expression intensity area 31b for the number of probes (the number of spots) immobilized to the microarray A(K) ‘M’ are secured in the spot record 31.

Next, the arithmetic unit 20 also stores the supplied array code of the microarray A(K) and the supplied probe codes of the probes p(1) to p(M) in the spot record for search 32 of the data set file apparatus 30 associating the probe codes to the array code (step S12).

In addition, the arithmetic unit 20 calculates standardized expression intensity Ep(1) (K) to Ep(M) (K) for each of the probes p(1) to p(M) based on the measurement value data of the expression intensity stored in the expression intensity area 31b of the spot record 31 and stores the standardized expression intensity Ep(1) (K) to Ep(M) (K) in both the spot record for search 32 and the standardized expression intensity area 32c of the spot record for search 32 associating them with the array code of the microarray A(K) and the probe codes of the probes p(1) to p(M) (step S13).

That is, one array code area 32a is added anew and the probe code area 32b and the standardized expression intensity area 32c for the number of probes (the number of spots) ‘M’ are added in the spot record for search 32 each time experimental results for the microarray A(K) is supplied to the arithmetic unit 20.

Consequently, the array code for the microarray A(K), the probe codes for the probes p(1) to p(M) immobilized to the spots sp(1) to sp(M) of the microarray A(K) and the standardized expression intensity Ep(1) (K) to Ep(M) (K) of the probes p(1) to p(M) are stored in the spot record for search 32 with respect to all the microarrays A(1) to A(N) used in the experiments performed in the past such that they are mutually searchable.

Therefore, symbols and numerical values indicated in FIG. 3 correspond to data contents accumulated in the spot record for search 32 such as array codes, probe codes and standardized expression intensity.

The search scheduling apparatus 1 of this embodiment is configured such that the processing for preparing and updating the interval record for a histogram 33 to be used in search processing is performed each time experimental results data is inputted and supplied together with processing for preparing data set for search (step S14) , whereby reduction of search time in processing for executing search discussed below is realized.

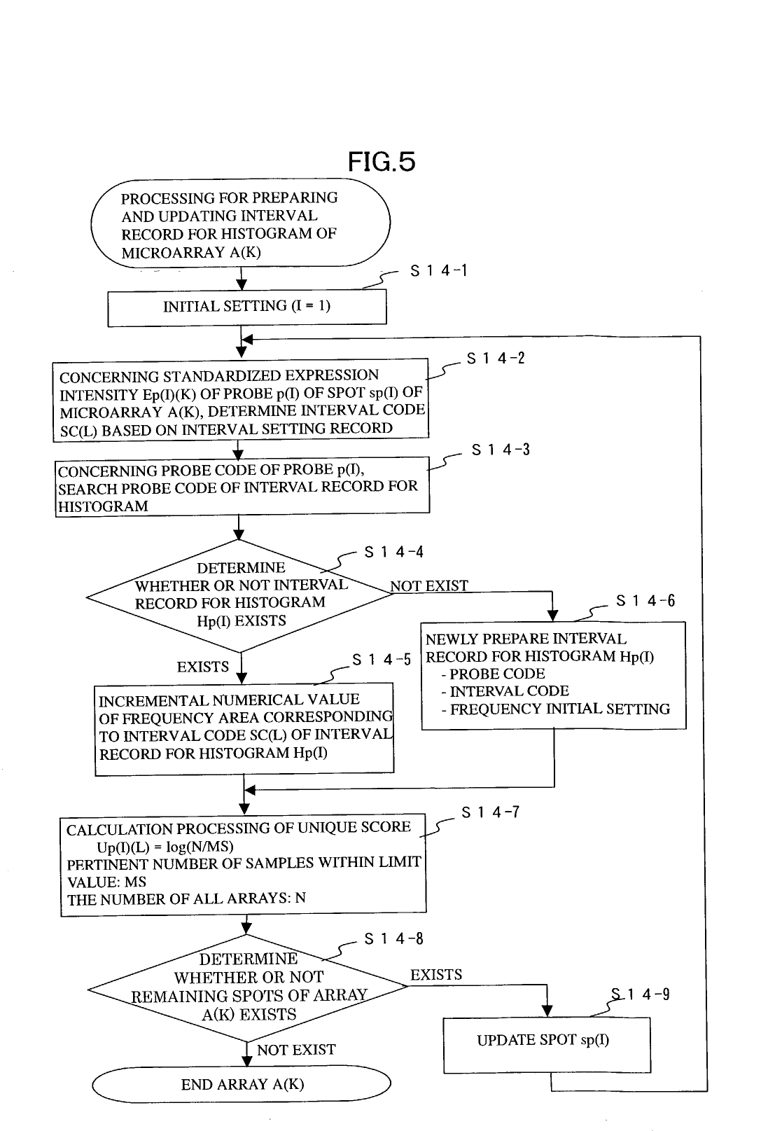

FIG. 5 is a flowchart showing an example of the processing for preparing and updating the interval record for a histogram 33.

The processing for preparing and updating the interval record for a histogram 33 is performed in the search scheduling apparatus 1 of this embodiment as follows.

After initial setting (step S14-1) , the arithmetic unit 20 refers to setting data of the lower limit area 34b and the upper limit area 34c of a standardized expression intensity for each interval code area 34a that is set in the interval setting record 34 of the data set file apparatus 30 in advance and determines which interval code SC(L) (L is an integer and 0<L≦10 in the case of this embodiment) the standardized expression intensity Ep(I) (K) of the probe p(I) immobilized to the microarray A(K), which is calculated in step S12, corresponds to (step S14-2).

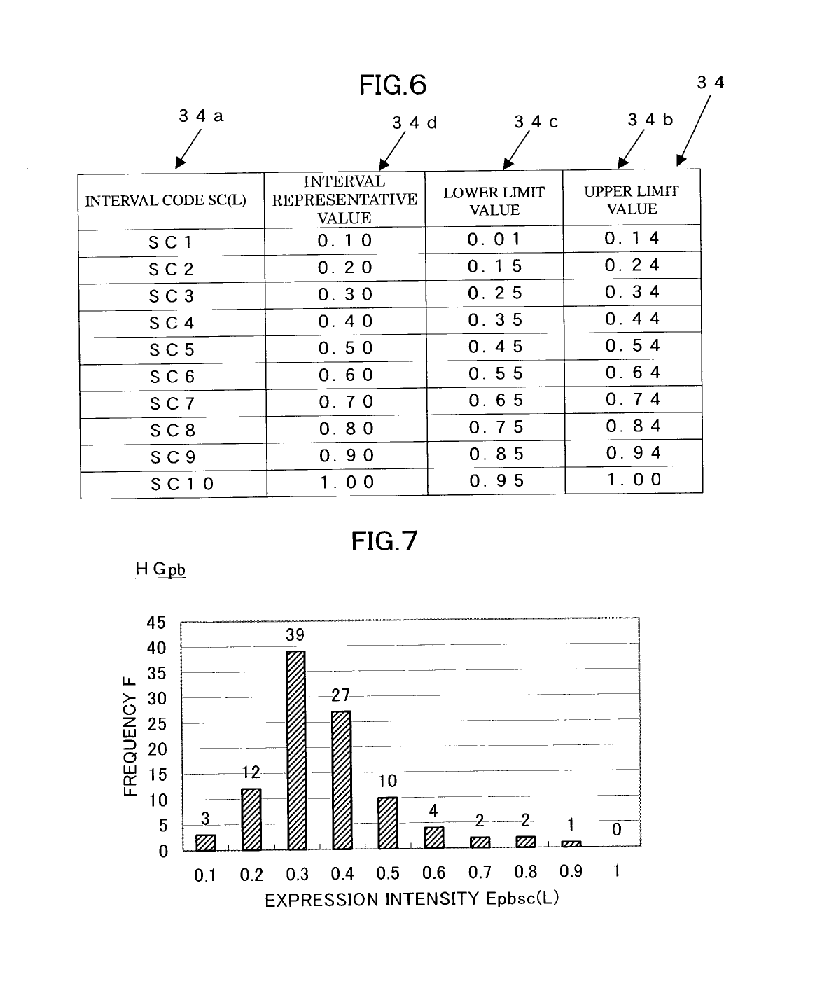

FIG. 6 is a table briefly showing a specific example of an interval setting record 34.

Explained with the microarray A(1) shown in FIG. 3 as an example, concerning a probe Pa for which the standardized expression intensity Epa(1) is ‘0.31’, its code is determined as ‘SC3’ and, in the same manner, an interval code of a probe Pb for which the standardized expression intensity Epb(1) is ‘0.53’ is determined as ‘SC5’ and an interval code for a probe Pc for which the standardized expression intensity Epc(1) is ‘0.07’ is determined as ‘SC1’.

Further, although, in the interval setting record 34 shown in FIG. 6, upper limit data and lower limit data are set such that upper limits and lower limits of intervals adjacent each other do not overlap, it is also possible to set upper limit data and lower limit data such that intervals adjacent each other partly overlap, make widths of intervals to be uniform or irregular or make the interval setting record 34 to be different from each other for each type of the probe p(I).

Then, after determining the interval record SC(L) for one probe p(I) of the microarray A(K), the arithmetic unit 20 searches the probe code area 33a of the interval record for a histogram 33 of the data set file apparatus 30 (step S14-3) and determines whether or not the same probe code as the probe p(I) exists in an interval record for a histogram Hp(I) in which probe codes are already stored (step S14-4)

If the interval record for a histogram Hp(I) of the same probe code already exists, the arithmetic apparatus 20 increments numerical value data of the frequency area 33c corresponding to the interval code area 33b, in which the same data as the determined interval code SC(L) is stored, by one (step S14-5).

Consequently, each time experimental data of a new microarray A(K) is filed in the spot record 31 and the spot record for search 32 of the data set file apparatus 30, histograms HG(1) to HG(M) of standardized expression intensities for the probes p(1) to p(M), which are already prepared based on data collection of the microarrays A(1) to A(K−1), are updated.

On the other hand, if the interval record for a histogram Hp(I) in which the same probe code is stored does not exist in the data set file apparatus 30 (i.e., if the probe p(I) is new), the arithmetic unit 20 sets the interval record for a histogram 33 for a probe code for the probe p(I) anew and sets ‘1’ in the frequency area 33c corresponding to the same interval code area 33b as the determined interval code SC(L) and, at the same time, sets ‘0’ in the frequency area 33c corresponding to a different interval code area 33b (step S14-6).

Consequently, new preparation of the interval record for a histogram Hp(I) is performed with respect to the new probe p(I) in the data set file apparatus 30.

Moreover, in the search scheduling apparatus 1 of this embodiment, upon completing the updating and preparation of the interval record for a histogram 33 for probe codes of one probe p(I) in steps S14-5 and S14-6, the arithmetic unit 20 performs processing for calculating a unique score Up(I) (L) that quantitatively indicates for the probe P(I) how characteristic each of the standardized expression intensities Ep(I) (sc1) to Ep(I) (sc10) (refer to FIG. 6) corresponding to interval codes SC1 to SC10 of the probe p(I) is (step S14-7).

Here, in describing the processing for calculating the unique score Up(I) (L) performed by the arithmetic unit 20, the unique score Up(I) (L) will be described first.

FIG. 7 illustrates an example of a histogram HGpb of a probe Pb that is prepared based on an interval record for a histogram Hpb of the probe Pb as a result of the processing for preparing and updating a histogram represented by the above-described steps S14-2 to S14-6.

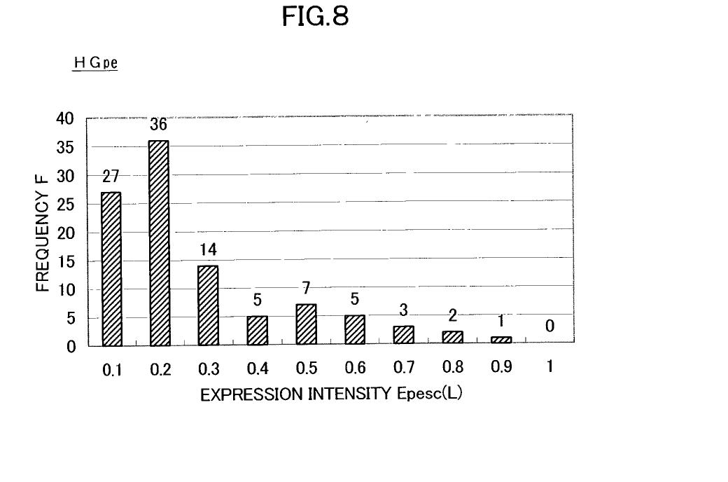

Similarly, FIG. 8 illustrates an example of a histogram HGpe of a probe Pe that is prepared based on an interval record for a histogram Hpe of the probe Pe.

In the histogram HGpb of the probe Pb shown in FIG. 7, a frequency ‘2’ for a value ‘0.70’ of a standardized expression intensity Epbsc(7) corresponding to its interval code SC7 is relatively low compared with a frequency F corresponding to other standardized expression intensities Epbsc(1) to Epbsc(6) and Epbsc(8) to Epbsc(10).

This indicates that the probe Pb hybridizes only with specific two kinds of samples sm(X1) and sm(X2) with the value ‘0.07’ of the standardized expression intensity Epbsc(7) and the probe Pb is very effective in specifying the two kinds of samples sm(X1) and sm(X2).

That is, the value ‘0.70’ of the standardized expression intensity Epbsc(7) of the probe Pb is an extremely characteristic value among a collection of values of standardized expression intensities Epbsc(1) to Epbsc(10) of the probe Pb, it is easy to identify or measure its expression phenomenon in an experiment and its importance is high.

In addition, in the histogram HGpe of the probe Pe shown in FIG. 8, a frequency ‘27’ corresponding to a value ‘0.1’ of its standardized expression intensity Epesc(1) is relatively large compared with frequencies corresponding to other standardized expression intensities Epesc(2) to Epesc(10).

This indicates that, with the value ‘0.1’ of the standardized expression intensity Epesc(1), the objective probe Pe hybridizes with each of specific twenty-seven kinds of samples sm(X1), sm(X2), . . . , sm(X27) and that the probe Pe is less effective in specifying a certain sample sm(XX) only among the twenty-seven samples sm(X1) to (X27).

Moreover, the value ‘0.1’ of the standardized expression intensity Epesc(1) is low in importance in that it is hard to identify or measure its expression phenomenon in an experiment.

That is, the value ‘0.1’ of the standardized expression intensity Epesc(1) of the probe Pe is not characteristic and less important among the collection of values of the standardized expression intensities Epesc(1) to Epesc(10) of the probe Pe.

Thus, in the search scheduling apparatus 1 of this embodiment, a unique score Up(I) (L) is defined which quantitatively indicates a degree of the probe p(I) hybridizing only with a specific sample sm(K) and not hybridizing with the other samples sm(exK) at a standardized expression intensity Ep(I)sc(L) corresponding to a predetermined interval code SC(L) and the processing for calculating the unique score Up(I) (L)is performed in step S14-7.

In this embodiment, with the processing for calculating the unique score Up(I) (L), the arithmetic unit 20 uses a predetermined threshold value range SA for the standardized expression intensity Ep(I)sc(L) to find a frequency F of probes of standardized expression intensities, that is, a total number of pertinent microarrays, in the threshold range SA and, then, calculates the unique score Up(I) (L). In this embodiment, the predetermined threshold range SA is defined in advance, for example, as follows.

Threshold range: Ep(I)sc(L)−0.2<SA<Ep(I)sc(L)+0.2 (Expression 1)

Then, given that the number of samples sm(K) of the predetermined threshold range SA is “MS” and the number of all samples sm(1) to (N), that is, the total number of microarrays A(K) for which experimental results are obtained is “N”, the unique score Up(I) (L) is defined as follows in this embodiment.

Unique score: Up(I)(L)=log(N/MS) (Expression 2)

Therefore, if a standardized expression intensity Ep(I)sc(L) corresponding to the predetermined interval code SC(L) of the pertinent probe p(I) does not have a characteristic, the number “MS” of the number of samples sm(K) in the predetermined threshold range SA becomes large to be close to the number of all samples “N” and the unique score Up(I) (L) approaches “0”.

On the other hand, the more the standardized expression intensity Ep(I)sc(L) corresponding to the predetermined interval code SC(L) of the pertinent probe p(I) becomes characteristic, the smaller the number “MS” of the samples sm(K) in the predetermined threshold range SA becomes and the larger the unique score Up(I) (L) becomes.

For example, processing for calculating a unique score Upb(L) performed by the arithmetic unit 20 is described as follows concerning the standardized expression intensity Epbsc(L) “0.1”, “0.2”, “0.3”, . . . , “1” corresponding to the predetermined interval code SC(L) in the histogram HGpb of the probe Pb shown in FIG. 7 with “0.5” and “0.7” among them as examples.

<Epbsc(5): 0.5>

Threshold range: 0.3<Epbsc(5)<0.7

Pertinent interval code (standardized expression intensity) and frequency of the probe p(b) in the threshold range:

SC4 (Epbsc(4)=0.4), F=27

SC5 (Epbsc(5)=0.5), F=10

SC6 (Epbsc(6)=0.6), F=4

Unique score: Upb(5)=log(100/41) (Expression 3)

N=100, MS=27+10+4=41

<Epbsc(7): 0.7>

Threshold range: 0.5<Epbsc(7)<0.9

Pertinent interval code (standardized expression intensity) and frequency of the probe p(b) in the threshold range:

SC6 (Epbsc(6)=0.6), F=4

SC7 (Epbsc(7)=0.7), F=2

SC8 (Epbsc(8)=0.8), F=2

Unique score: Upb(7)=log(100/8) (Expression 4)

N=100, MS=4+2+2=8

Similarly, processing for calculating a unique score Upe(L) performed by the arithmetic unit 20 is described as follows concerning the standardized expression intensity Epesc(L) “0.1”, “0.2”, “0.3”, . . . , “1” corresponding to the predetermined interval code SC(L) in the histogram HGpe of the probe Pe shown in FIG. 8 with “0.1” and “0.2” among them as examples.

<Epesc(1): 0.1>

Threshold range: 0<Epesc(1)<0.3

Pertinent interval code (standardized expression intensity) and frequency of the probe pe in the threshold range:

SC1 (Epesc(1)=0.1), F=27

SC2 (Epbsc(2)=0.2), F=36

Unique score: Upe(1)=log(100/63) (Expression 5)

N=100, MS=27+36 =63

<Epesc(2): 0.2>

Threshold range: 0<Epbsc(2)<0.4

Pertinent interval code (standardized expression intensity) and frequency of the probe pe in the threshold range:

SC1 (Epesc(1)=0.1), F=27

SC2 (Epbsc(2)=0.2), F=36

SC3 (Epbsc(3)=0.31), F=14

Unique score: Upe(2)=log(100/77) (Expression 6)

N=100, MS=27+36+14=77

Then, in step S14-7, as described above, the arithmetic unit 20 calculates the unique score Up(I) (L) corresponding to the predetermined interval code SC(L) of the probe p(I) and stores the processing for calculating the unique score Up(I) (L) results in a unique score area 33d associated with the interval code SC(L) to be provided in the interval record for a histogram 33 of the probe p(I) and updates the unique score area 33d.

In this way, the arithmetic unit 20 performs the processing for updating and preparing the histograms HGp(1) to HGP(M) (steps S14-2 to S14-6) and the processing for calculating and updating the unique score Up(I) (L) of the unique score area 33d (step S14-7) with respect to the probe p(I) immobilized to the micro array A(K). Then, the arithmetic unit 20 confirms whether or not as pot sp(I) for which the processing for up dating and preparing the histogram HGP(I) and the processing for calculating and updating the unique score Up(I) (L) of the unique score area 33d have not been performed yet remains in the spot record 31 (step S14-8) and, if it remains, updates the spot sp(I), that is, the probe p(I) to perform the processing of steps S14-2 to S14-8.

Further, in this embodiment, the probe code of the probe p(I) stored in the spot record 31 and the measurement value of the expression intensity measured for each of the spots sp(1) to sp(M) are reset when new experimental results data is supplied after preparing and updating the interval record for a histogram 33 concerning the probe p(I).

In addition, the measurement value of the expression intensity measured for each of the spots sp(1) to sp(M) may be stored in the spot record for search 32 even after the processing for preparing and updating an interval record for a histogram of the microarray A(K) . In this case, the spot record for search 32 can serve as the spot record 31, which can be omitted.

Next, processing for executing search performed by the search scheduling apparatus 1 will be described.

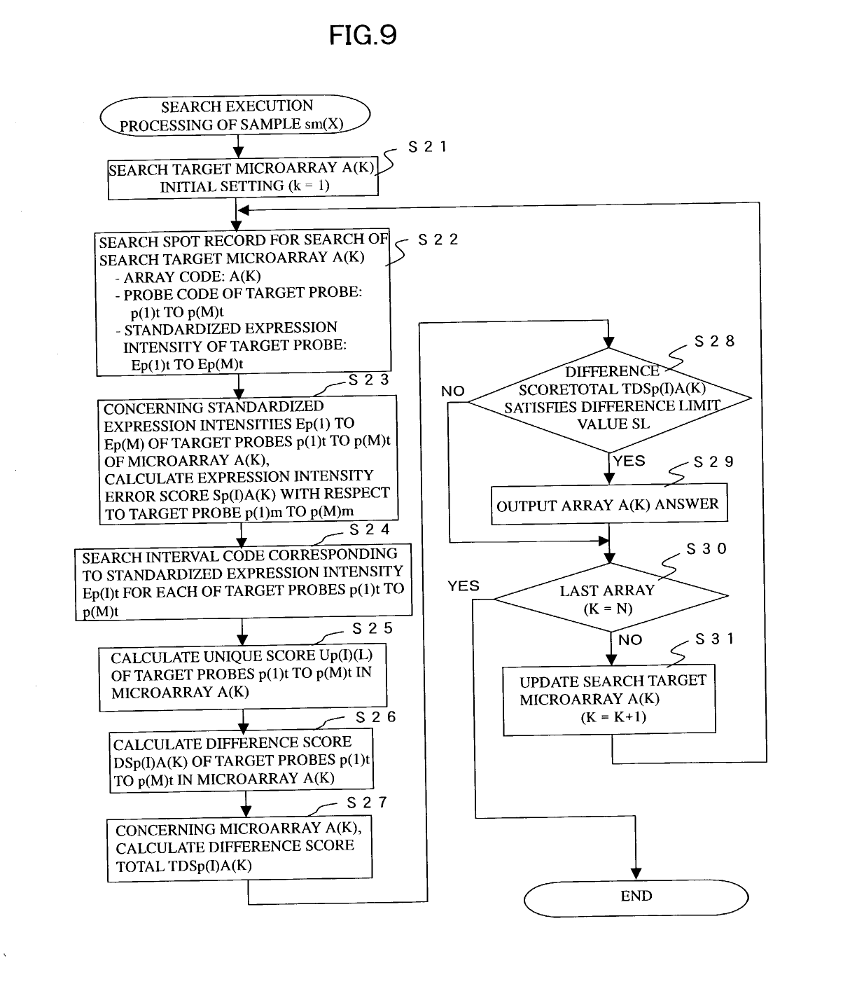

FIG. 9 is a flow chart showing processing for executing search performed by the arithmetic unit 20 of the search scheduling apparatus 1 in the processing.

Here, the processing will be described with the case in which a sample sm(X) (1≦X≦N) causing hybridization of the standardized expression intensity ‘0.72’ with the probe Pb and causing hybridization of the standardized expression intensity ‘0.01’ with the probe Pe as search conditions as an example.

Further, in order to distinguish the probe Pb and the probe Pe used as search conditions in the description from the probe Pb and the probe Pe stored in the interval record for a histogram 33 of the data set file apparatus 30 as a search object, in the following description, the former robes are referred as an objective probe Pbm and an objective probe Pem and the latter probes are referred to as an objective probe Pbt and an objective probe Pet to distinguish both of them from each other and described.

First, when the objective probes Pbm [0.72] and Pem [0.01] are set by, for example, the keyboard apparatus 11 of the input/output apparatus 10, the arithmetic unit 20 of the search scheduling apparatus 1 in which the objective probes are inputted performs initial setting of the microarray A(K) (step S21) , searches a spot record for search of a predetermined microarray A(K) that is subject to initial setting or update setting out of spot records for search of the microarrays A(1) to A(N) stored in the spot record for search 32 of the data set file apparatus 30, respectively, and reads out its array code and standardized expression intensities Epbt and Epet of the objective probes Pbt and Pet corresponding to the objective probes Pbm and Pem (step S22).

Incidentally, values of the read out standardized expression intensities Epbt and Epet of the objective probes Pbt and Pet corresponding to the objective probes Pbm and Pem usually have a difference between standardized expression intensities Epbm and Epem of the objective probes Pbm and Pem.

For example, concerning the microarrays A(3) and A(7) shown in FIG. 3, when attention is paid to a value ‘0.72’ of the standardized expression intensity Epbt of the objective probe Pbm as a search condition, a value ‘0.52’ of the standardized expression intensity Epbt of the objective probe Pbt of the microarray A(3) has a difference of ‘0.20’ from the objective probe Pbm. On the other hand, a value ‘0.70’ of the standardized expression intensity Epbt of the objective probe Pbt of the microarray A(7) has a difference of only ‘0.02’ from the objective probe Pbm.

Therefore, when attention is paid only to the objective probe Pbm, the microarray A(7), that is, the sample sm(7) has higher similarity to a standardized expression intensity with respect to the sample sm(X) as a search object than the microarray A(3), that is, the sample sm(3).

However, when attention is paid to the value ‘0.01’ of the standardized expression intensity Epbt of the objective probe Pem also as a search condition, the value ‘0.21’ of the standardized expression intensity Epet of the objective probe Pet of the microarray A(7) has the difference of ‘0.20’ from the objective probe Pem, whereas the value ‘0.02’ of the standardized expression intensity Epet of the objective probe Pet of the microarray A(3) has only the difference of ‘0.01’ from the objective probe Pbm. Thus, the similarity with respect to the standardized expression intensity of the sample sm(X) as a search object is reversed.

Thus, the arithmetic unit 20 calculates expression intensity error scores Sp(I)A(K) between the standardized expression intensities Epbm and Epem of the objective probes Pbm and Pem and the standardized expression intensities Epbt and Epet of the objective probes Pbt and Pet of the microarray A(K) corresponding to the objective probes Pbm and Pem (step S23)

The expression intensity error score Sp(I)A(K) is for quantitatively representing a difference (distance) between a standardized expression intensity Ep(I)m of each objective probe p(I)m and a standardized expression intensity Ep(I)t of an objective probe p(I)t of the microarray A(K) and is found as follows.

Sp(I)A(K)=1-absolute(Ep(I)m−Ep(I)A(K)t) (Expression 7)

Ep(I)m: standardized expression intensity of the objective probe p(I)m

Ep(I)A(K)t: standardized expression intensity of the objective probe p(I)t of the array A(K) corresponding to the standardized expression intensity Ep(I) of the objective probe p(I)m

Then, when the expression intensity error score Sp(I)A(K) of each of the objective probes Pbm and Pem is calculated as follows with the microarray A(3) and the microarray A(7) as examples.

SpbA(3)=1-absolute(0.72-0.52)=0.8 (Expression 8)

SpbA(7)=1-absolute(0.72-0.70)=0.9 (Expression 9)

SpeA(3)=1-absolute(0.01-0.02)=0.99 (Expression 10)

SpeA(7)=1-absolute(0.01-0.21)=0.8 (Expression 11)

Therefore, the smaller a difference of the standardized expression intensity Ep(I)t of the objective probe p(I)t in the microarray A(K) corresponding to the objective probe p(I)m becomes with respect to the standardized expression intensity Ep(I)m of the objective probe p(I)m, the closer the expression intensity error score Sp(I)A(K) approaches ‘1’.

That is, the closer a value of the expression intensity error score Sp(I)A(K) is to ‘1’, the higher possibility of similarity of the objective probe p(I)t to the objective probe p(I)m in the array A(K) becomes and the more possibility of identicalness increases.

However, as described above, when the objective probe p(I)t has only the possibility of similarity to the objective probe p(I)m of only the expression intensity error score Sp(I)A(K), the similarity may be reversed between one microarray A(K1) and another microarray A(K2).

Thus, the arithmetic unit 20 finds the above-described unique score Up(I)(L) for the objective probe p(I)t next.

In finding the unique score Up(I) (L), in this embodiment, the arithmetic unit 20 refers to the interval setting record 34 of the data set file apparatus 30 based on the standardized expression intensity Ep(I)t for each objective probe p(I)t corresponding to the objective probe p(I)m to search an interval code corresponding to the standardized expression intensity Ep(I)t of the objective probe p(I)t (step S24).

Then, for each of the target probe p(I) t, the arithmetic unit 20 searches the unique score area 33d of the interval record for a histogram 33 of each objective probe p(I)t based on the probe code of the objective probe p(I)t obtained from the spot record for search 32.

In searching the unique score area 33d, the arithmetic unit 20 reads out stored contents of the unique score 33d corresponding to the interval code area 33b in which the pertinent interval code of the searched interval record for a histogram 33, that is, the unique score Up(I) (L) that is calculated in advance with respect to the expression intensity Ep(I)t of the objective probe p(I)t (see step S14-7) based on the interval code obtained from the interval setting record 34 in advance.

In this way, in the case of this embodiment, the arithmetic unit 20 calculates the unique score Up(I) (L) of the objective probe p(I)t in the microarray A(K) without performing numerical value calculation at the time of execution of search (step S25).

Thereafter, the arithmetic unit 20 aggregates similarity and characteristics with respect to the objective probe p(I)m corresponding to each objective probe p(I)t based on the expression intensity error score Sp(I)A(K) obtained for each objective probe p(I)t of the microarray A(K) and the unique score Up(I) (L).

In aggregating similarity/identity and characteristics of one objective probe p(I)t corresponding to this one objective probe p(I)m, a difference score DSp(I)A(K) as in the following expression is defined and calculated in this embodiment (step S26).

$$\begin{matrix}\text{Difference score:} D Sp ( I ) A ( K ) \\ = Sp ( I ) A ( K ) * Up ( I ) ( L ) \\ = [ C1 - absolute ( Ep ( I ) m - \\ Ep ( I ) A ( K ) t ) ] * log ( N / MS )\end{matrix} \qquad \text{(Expression 12)}$$

(Expression 12)

Sp(I)A(K): expression intensity error score of the objective probe p(I)t

Up(I)(L): unique score of the objective probe p(I)t

C1: constant (in this embodiment, C1=1)

Difference scores DSpbA(3), DspeA(3), DspbA(7) and DspeA(7) of each of the objective probes Pbm and Pem are calculated for this difference score DSp(I)A(K) , as follows with the objective probes Pbm and Pem as examples.

$$\begin{matrix}\begin{matrix}DSpbA ( 3 ) = SpbA ( 3 ) * Upb ( 5 ) \\ = [ 1 - absolute ( 0.72 - 0.52 ) ] * \\ log ( 100 / 41 ) \\ = 0.310\end{matrix} & \text{(Expression 13)} \\ \begin{matrix}DSpeA ( 3 ) = SpeA ( 3 ) * Upe ( 1 ) \\ = [ 1 - absolute ( 0.01 - 0.02 ) ] * \\ log ( 100 / 63 ) \\ = 0.199\end{matrix} & \text{(Expression 14)} \\ \begin{matrix}DSpbA ( 7 ) = SpbA ( 7 ) * Upb ( 7 ) \\ = [ 1 - absolute ( 0.72 - 0.70 ) ] * \\ log ( 100 / 8 ) \\ = 1.075\end{matrix} & \text{(Expression 15)} \\ \begin{matrix}DSpeA ( 7 ) = SpeA ( 7 ) * Upe ( 2 ) \\ = [ 1 - absolute ( 0.01 - 0.21 ) ] * \\ log ( 100 / 77 ) \\ = 0.091\end{matrix} & \text{(Expression 16)}\end{matrix}$$

Therefore, according to this difference score DSp(I)A(K), the characteristic of an expression intensity of the objective probe p(I)t represented by the unique score Up(I) (L) is added to the similarity of the objective probe p(I)t and the objective probe p(I)m in terms of an expression intensity (standardized expression intensity) represented by the expression intensity error score Sp(I)A(K), whereby the objective probe p(I)t is more narrowed with respect to the sample sm(X) as the search objective.

Thereafter, the arithmetic unit 20 calculates a difference score total TDSp(I)A(K) described below for the sample sm(K) applied to the microarray A(K) in order to find similarity with respect to the sample sm(X) as the search object whose search conditions are set in the objective probe p(I)m (step S27).

Difference score total: TDSp(I)A(K)=Σ[DSp(I)A(K)] (Expression 17)

Here, for example, difference score totals TDSp(I)A(3) and TDSp(I)A(7) are calculated for the above-described microarray A(3) and microarray A(7) as follows.

$$\begin{matrix}\begin{matrix}TDSp ( I ) A ( 3 ) = TDSpbA ( 3 ) + TDSpeA ( 3 ) \\ = 0.310 + 0.199 = 0.509\end{matrix} & \text{(Expression 18)} \\ \begin{matrix}TDSp ( I ) A ( 7 ) = TDSpbA ( 7 ) + TDSpeA ( 7 ) \\ = 1.075 + 0.091 = 1.166\end{matrix} & \text{(Expression 19)}\end{matrix}$$

This difference score total TDSp(I)A(K) is used when there are a plurality of objective probes p(I)m as search conditions. The higher the similarity of the sample sm(K) applied as a target to the microarray A(K) with respect to the sample sm(X) as the search target, the larger the value of the difference score total TDSp(I)A(K) becomes.

Thus, the arithmetic unit 20 calculates the difference score total TDSp(I)A(K) for the microarray A(K) and, then, determines if its value exceeds a difference score total limit value SL set as a difference limit value in advance (stepS28) Further, this difference score total limit value SL is appropriately set in advance taking into consideration the number of the objective probes p(I)m, search results in the past or the like when search is performed.

Then, if the value of the difference score total TDSp(I)A(K) exceeds this difference score total limit value SL, the arithmetic unit 20 determines that the sample sm(K) that is applied as a target to the microarray A(K) has similarity or identity of being the sample sm(X) of the search object and outputs data for the microarray A(K), that is, the sample sm(K) to the input/output apparatus 10 as an answer (step S29) On the other hand, the arithmetic unit 20 determines whether or not the microarray A(K) is the last microarray A(K) in the search range set as the search object range in advance by the input/output apparatus 10 (step S30).

If the microarray A(K) is not the final microarray A(K) of the search object range and there is unconfirmed remaining microarray A(K), the arithmetic unit 20 updates and sets the microarray A(K) of a search object (step S31) and repeats the processing for steps S22 to S30 until there is no unconfirmed remaining microarray A(K).

Therefore, according to the search scheduling apparatus 1 of this embodiment, if the expression intensity Ep(I) of the probe P(I), which hybridizes with the sample sm(X) as the search condition, that is, the expression intensity Ep(I)t of the objective probe P(I)t, is set and inputted for a desired sample sm(X) that a user wishes to search by the input/output apparatus 10, the arithmetic unit 20 finds out the microarray A(K) satisfying the search conditions based on a record of experimental results accumulated in the data set file apparatus and displays search results on the input/output apparatus 10.

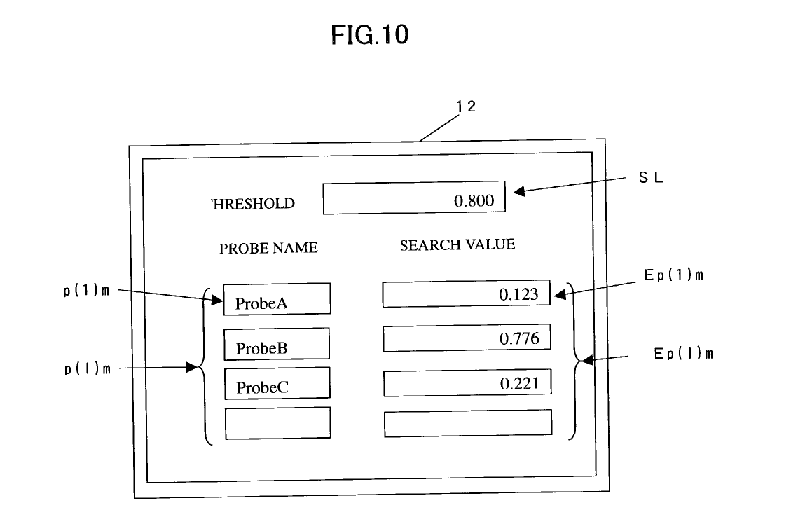

FIG. 10 shows an example of display by the display apparatus 12 of the input/output apparatus 10 when search conditions are set and inputted.

In this example of display, the search conditions are ordered and the set difference score total limit value SL and the standardized expression intensity Ep(I)m of the objective probe p(I)m are displayed.

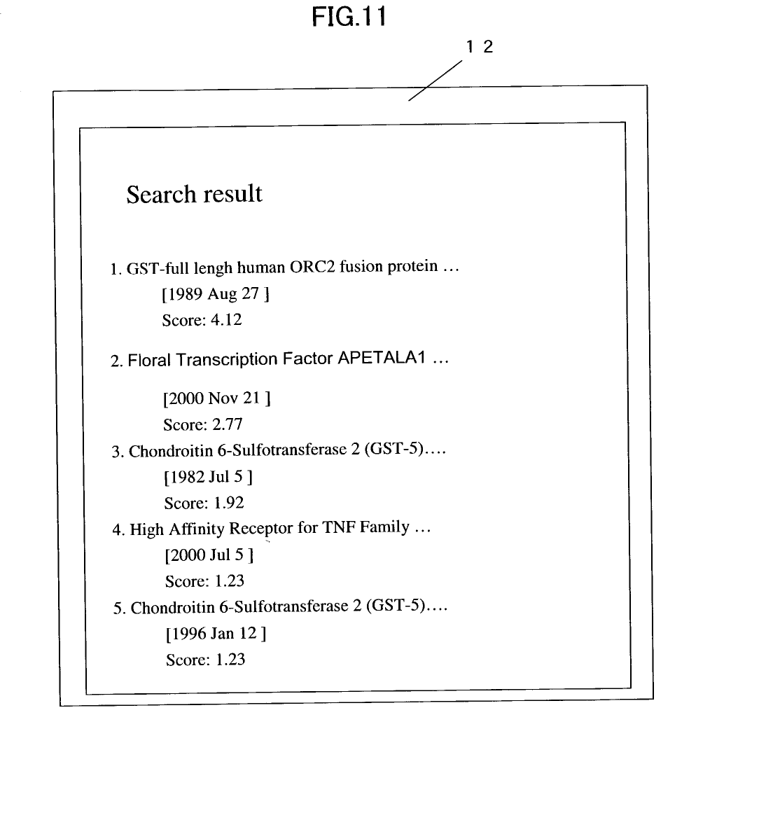

FIG. 11 shows an example of display by the display apparatus 12 of the input/output apparatus 10 for search results.

Further, although the search scheduling apparatus is configured such that the difference limit value SL is set only for the difference score total TDSp(I)A(K) as described in step S28 in the above-described embodiment, the present invention is not limited to this and the search scheduling apparatus may be configured such that a difference limit value SLp(I)m is set for each objective probe p(I)m, a difference score Sp(I)A(K) for each objective probe p(I)t is compared with this difference limit value SLp(I)m to be determined and its results are regarded as search results. Then, in this case, the processing for calculating the difference score total TDSp(I)A(K) indicated in step S27 may be excluded. In addition, the search scheduling apparatus may be configured such that, after comparing the difference score Sp(I)A(K) of each objective probe p(I)t with this difference limit value SLp(I)m to determine it, the difference score total TDSp(I)A(K) is further compared with the difference limit value SL.

Moreover, in the search scheduling apparatus 1 in accordance with the above-described embodiment, since it is configured such that calculation of the standardized expression intensity Ep(I), preparation of the histogram HGP(I) and calculation of the unique score Up(I)(L) are performed in advance prior to search, search can be performed faster than calculating them each time search is performed. However, if it is not necessary to consider a search speed so much, the search scheduling apparatus 1 may be configured such that these are calculated each time search is performed.

Incidentally, in the search scheduling apparatus 1 of the above-described embodiment, if a plurality of microarrays A(1) to A(N) (i.e., samples sm(1) to sm(N)) are combined and reacted to one probe p(1), in relation to a magnitude of its expression intensity the unique score Up(I) (L) represents how unique each microarray A(K) (i.e., sample sm(K)) is compared with the other microarrays A(not K) (i.e., the other samples sm(not K)).

Then, the search scheduling apparatus 1 designates a standardized expression intensity Ep(I) for each probe type to prepare a histogram of the microarrays A(1) to A(N) (see FIGS. 7 and 8)and searches an array A(X) having an object expression pattern out of a group of arrays of the plurality of microarrays A(1) to A(N) to be a target.

However, the unique score U of the present invention is not limited to only such a unique score Up(I) (L). In addition, the search scheduling apparatus 1 is not configured to be limited only to this unique score Up(I) (L).

For example, if a plurality of probes p(1) to p(M) immobilized to the microarray A(K) are combined and reacted to the sample sm(K) as one target, in relation to a magnitude of its expression intensity, a unique score Ua(K) (L) can be envisaged which represents how unique each probe p(I) is with respect to this sample sm(K) compared with the other probes p(not I).

In this case, the search scheduling apparatus 1 designates a standardized expression intensity Esm(K) for each sample type to prepare the histogram of the probes p(1) to p(M) (see FIGS. 7 and 8) and searches a probe p(X) having an objective expression pattern out of a group of probes of the plurality of probes p(1) to p(M) to be a target.

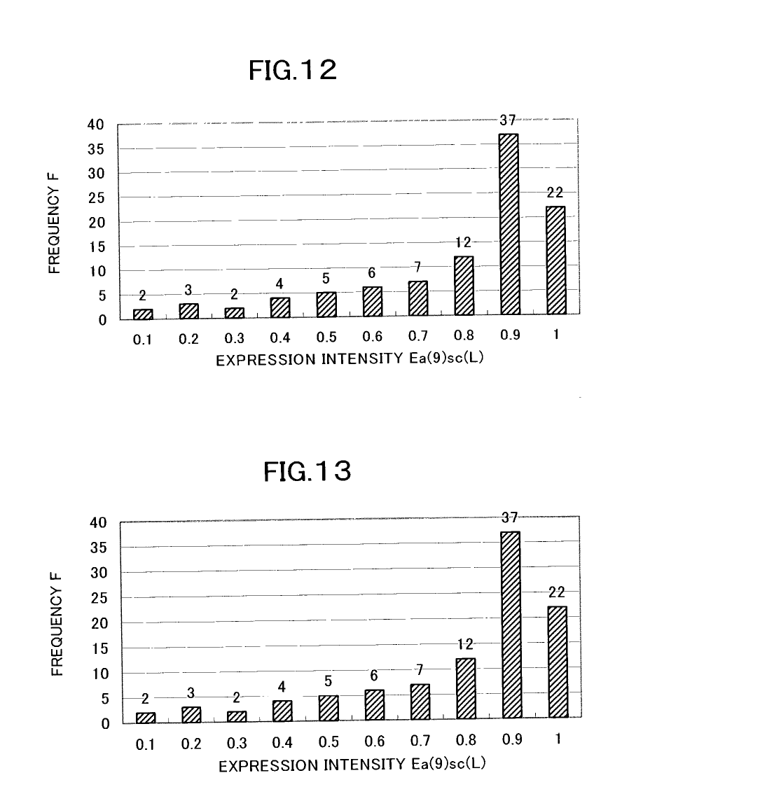

FIG. 12 shows an example of the histogram HGa(2) of the microarray A(2) that is prepared based on, for example, the interval record for a histogram Ha(2) of the microarray A(2) FIG. 13 shows an example of the histogram Hga(9) of the microarray A(9) that is prepared based on, for example, the interval record for a histogram Ha(9) of the microarray A(9).

The case in which a probe p(X), for example, having an expression intensity of ‘0.72’ with respect to the sample sm(2) of the microarray A(2) and having an expression intensity of ‘0.01’ with respect to the sample sm(9) of the microarray A(9) is considered and specifically described for the search of this probe p(X) with the histograms Hga(2) and Hga(9) of FIGS. 12 and 13 as examples.

In this case, given that the number of target probes in the threshold range SA set in advance in one microarray A(K), that is, the sample sm(K) is ‘MP’ and the total number of probes to which one microarray A(K), that is, the sample sm(K) is applied is ‘M’, the unique score Ua(K) (L) is as follows.

Unique score: Ua(K)(L)=log(M/MP) (Expression 20)

In addition, this expression intensity error score Sa(K)p(I) is as follows.

Sa(K)p(I)=C1-absolute(Ea(K)m−Ea(K)p(I)t) (Expression 21)

Ea(K)m: Standardized expression intensity of the target sample a(K)m

Ea(K)p(I)t: Standardized expression intensity of the target sample a(K)m corresponding to the standardized expression intensity Ea(K)m of the target sample a(K)m

C1: Constant (e.g., C1=1)

$$\begin{matrix}\text{Difference Score:} Dsa ( K ) p ( I ) \\ = Sa ( K ) p ( I ) * Ua ( K ) ( L ) \\ = [ C1 - absolute ( Ea ( K ) m - \\ Ea ( K ) p ( I ) t ) ] * log ( M / MP )\end{matrix} \qquad \text{(Expresssion 22)}$$

(Expression 22)

Sa(K)p(I) : Expression intensity error score of the target sample a(K)t

Ua(K)(L): Unique score of the target sample a(K)t

C1: Constant (in this embodiment, C1=1)

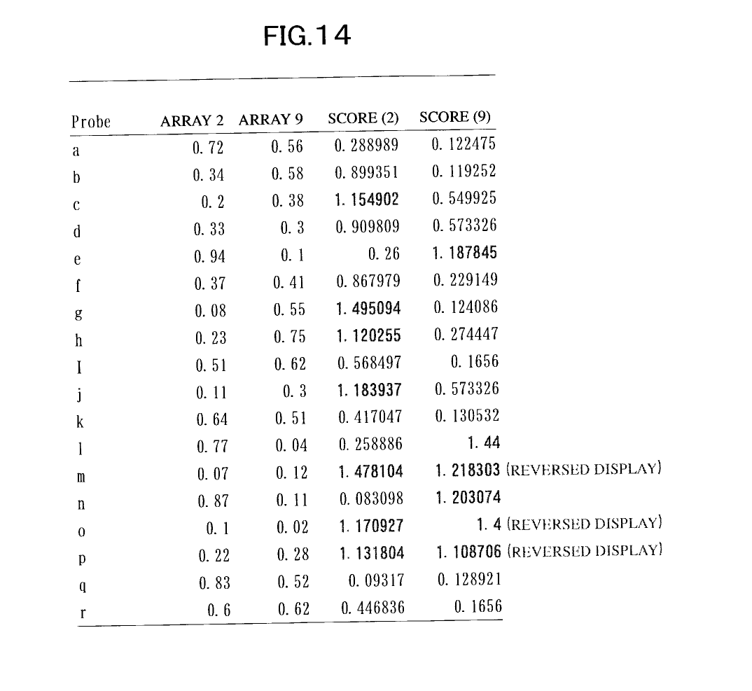

FIG. 14 shows an example of display for search results of this probe p(X) by the display apparatus 12 of the input/output apparatus 10.

In this case, a difference limit value is provided with respect to a difference score DSa(K)p(I) for each of the microarrays A(2) and A(9), and a difference score Dsa(2)p(X) of the microarray A(2) of the probe p(X) exceeding the difference limit value and a difference score Dsa(9)p(X) of the microarray A(9) are distinguished from difference scores Dsa(2)p(not X) and Dsa(2)p(not X) not exceeding the difference limit value to be identified and displayed by reversed display or the like.

According to this result, since probes for which the difference score DSa(K)p(I) exceeds one in both the microarray A(2) and microarray A(9) are probes Pm, Po and Pp, these are regarded as search results. In addition, it is also possible to calculate a total TDSa(K)p(I) of the difference score DSa(K)p(I) as in the above-described embodiment to use it as a result.

In this embodiment, the search scheduling apparatus can be utilized for searching the probe p(X) indicating a certain kind of change pattern in time series.

As described above, according to the present invention, it becomes possible to inhibit influence that a group of spots of nonspecific reaction and an error of reaction give to arrangement and search to arrange and search data having an objective characteristic (a microarray, a sample as a target, individual data such as a probe) out of experimental results data of an experiment using microarrays.

What is claimed is:

1. A search scheduling apparatus comprising:
a data set file having a record for search in which a value of expression intensity of each spot on a microarray provided with a spot to which a probe is immobilized is stored in the case where a target is applied to the microarray, and a record for histogram in which, based on a value of expression intensity for each probe type or microarray which is stored in the record for search, the number of microarrays or probes according to a value of expression intensity for each probe type or microarray is stored; and
search means for searching, when a predetermined value of expression intensity for one probe or microarray is input as a search condition, the record for search for a probe or microarray of the search condition, so that a desired microarray or probe can be identified based on uniqueness on a histogram of expression intensity for each probe or microarray which is searched from the record for histogram.

2. The search scheduling apparatus according to claim 1, wherein the uniqueness on the searched histogram of expression intensity for each probe or microarray is judged based on a score representing a degree of uniqueness.

3. A program for causing a computer to function as a search scheduling apparatus, the apparatus comprising:
a data set file having a record for search in which a value of expression intensity of each spot on a microarray provided with a spot to which a probe is immobilized is stored in the case where a target is applied to the microarray, and a record for histogram in which, based on a value of expression intensity for each probe type or microarray which is stored in the record for search, the number of microarrays or probes according to a value of expression intensity for each probe type or microarray is stored; and
search means for searching, when a predetermined value of expression intensity for one probe or microarray is input as a search condition, the record for search for a probe or microarray of the search condition, so that a desired microarray or probe can be identified based on uniqueness on a histogram of expression intensity for each probe or microarray which is searched from the record for histogram.

4. A computer-readable recordig medium having recorded therein a program for causing a computer to function as a seaerch scheduling apparatus, the apparatus comprising:
a data set file having a record for search in which a value of expression intensity of each spot on a microarray provided with a spot to which a probe is immobilized is stored in the case where a target is applied to the microarray, and a record for histogram in which, based on the value of expression intensity for each probe type or microarray which is stored in the record for search, the number of microarrays or probes according to a value of expression intensity for each probe type or microarray is stored; and
search means for searching, when a predetermined value of expression intensity for one probe or microarray is input as a search condition, the record for search for a probe or microarray of the search condition, so that a desired microarray or probe can be identified based on uniqueness on a histogram of expression intensity for each probe or microarray which is searched from the record for histogram.

5. A search scheduling apparatus comprising:
a data set file having a record for search in which a value of expression intensity for each spot on a microarray with at least one spot to which one probe is immobilized is stored in the case where a target is applied to the microarray, and a record for histogram in which, based on a value of expression intensity for each spot on the microarray which is stored in the record for search, the number of microarrays having a spot provided with a probe of a predetermined kind is stored while being classified according to predetermined intervals of the value of expression intensity, for each kind of probe immobilized to the spot of the microarray; and
search means for searching, when a predetermined value of expression intensity for a probe of a predetermined kind is input as a search condition for searching for a desired microarray, the record for search for a microarray with a spot to which the probe of the predetermined kind is immobilized, and determining the uniqueness of the value of expression intensity of the probe of the predetermined kind in the searched microarray on the basis of the number of microarray that is stored in the histogram for the probe of the predetermined kind and which is of a value interval containing the value of expression intensity of the probe of the predetermined kind in the searched microarray, so that a desired microarray can be identified from the searched microarray on the basis of the uniqueness determined for each searched microarray.

6. A search scheduling apparatus comprising:
a data set file having a record for search in which a value of expression intensity for each spot on a microarray with at least one spot to which one probe is immobilized is stored in the case where a target is applied to the microarray, and a record for histogram in which, based on a value of expression intensity for each spot on the microarray which is stored in the record for search, the number of probes immobilized to the spot on the microarray to which a target of a predetermined kind is applied is stored while being classified according to predetermined intervals of value of expression intensity, for each kind of target applied to the microarray; and
search means for searching, when a value of expression intensity for a target of a predetermined kind is input as a search condition for searching for a desired microarray, the record for search for a microarray to which the target of the predetermined kind is applied, and determines the uniqueness of the value of expression intensity of the probe immobilized to each spot on the searched microarray on the basis of the number of the probes for each value section which are stored in the record for histogram for the target of the predetermined kind, so that a microarray with a spot to which a desired probe is immobilized can be identified from the searched microarray on the basis of the uniqueness determined for each searched probe.
